(19) United States
(12) Patent Application Publication
(10) Pub. No.: US 2022/0333568 A1
(43) Pub. Date: Oct. 20, 2022

(54) High-Pressure Fuel Pump

(71) Applicant: Robert Bosch GmbH, Stuttgart (DE)

(72) Inventors: Stefan Kolb, Rottweil (DE); Daniel Beckmann, Eberdingen (DE)

(21) Appl. No.: 17/633,093

(22) PCT Filed: Jul. 22, 2020
(86) PCT No.: PCT/EP2020/070631

§ 371 Date: Feb. 4, 2022

(30) Foreign Application Priority Data
Aug. 9, 2019 (DE) 10 2019 212 005.9

(51) Int. Cl. F02M 37/00; F02M 59/48

(52) U.S. Cl. CPC F02M 37/0041; F02M 59/48; F02M 2200/8084; F02M 2200/8023

(57) ABSTRACT

A high-pressure fuel pump includes a pump housing, a receiving space in the pump housing, a pressure pulsation damper in the form of a diaphragm cell having two diaphragms, which pressure pulsation damper is arranged in the receiving space, and a holding device for holding the diaphragm cell in the receiving space. The holding device includes a connection portion, which is connected to the pump housing rigidly both in an axial direction and in a radial direction. The connection portion is fastened to the pump housing, both in the axial direction and in the radial direction, to an inner lateral surface of the pump housing that delimits the receiving space.

### PRIOR ART

The invention relates to a high-pressure fuel pump according to the preamble of claim 1.

DE 10 2015 219 537 A1 describes a high-pressure fuel pump that is used in a fuel system of an internal combustion engine. Said high-pressure fuel pump is used to compress the fuel to a very high pressure, in order for said fuel to then be injected directly into the combustion chambers of the internal combustion engine by means of injectors. The known high-pressure fuel pump is a piston pump, the delivery rate of which can be influenced by an inlet-side flow rate control valve. This results in pressure pulsations being generated in an inlet-side low-pressure region, which pressure pulsations are reduced by means of a pressure pulsation damper arranged there. Said pressure pulsation damper comprises a diaphragm cell with, for example, two diaphragms arranged substantially approximately parallel to one another, which diaphragms are welded to one another at the edge. In a receiving space of a pump housing, the diaphragm cell is clamped between a holding ring and a spring.

### DISCLOSURE OF THE INVENTION

The problem on which the present invention is based is solved by means of a high-pressure fuel pump having the features of claim 1. Advantageous refinements of the invention are specified in subclaims.

The high-pressure fuel pump according to the invention comprises a low-pressure region and a pressure pulsation damper arranged in the low-pressure region. The expression “low-pressure region” refers to an inlet-side region upstream of the compression of the fuel. The pressure pulsation damper comprises at least one diaphragm cell and is arranged in a receiving space which is delimited, for example, by a housing cover of the high-pressure fuel pump.

The diaphragm cell preferably has two diaphragms, which may for example be arranged mirror-symmetrically with respect to one another, and between which an interior space of the pressure pulsation damper is formed, which interior space is delimited by said diaphragms. The interior space may for example be filled with a compressible gaseous fluid (for example air or nitrogen), such that, in the presence of particular ambient conditions, a particular pressure prevails in the interior space.

A holding device is provided for holding the diaphragm cell in the receiving space. According to the invention, said holding device comprises a connecting section which is fixedly connected both in an axial direction and in a radial direction to the pump housing and which in particular is fastened both in an axial direction and in a radial direction to an inner lateral surface that delimits the receiving space. Thus, in the case of the high-pressure fuel pump according to the invention, the holding ring that was hitherto present and the spring that was hitherto present are omitted. Instead, the diaphragm cell is fastened both in an axial direction and in a radial direction to the pump housing by means of the holding device and the connecting section thereof. Here, an axial and a radial direction can be referred to in the present case because the diaphragm cell is conventionally a part that is, at least in certain sections and at least substantially, rotationally symmetrical.

The invention has the effect that the hitherto provided components of holding ring and spring can be omitted, whereby costs can be saved and the required axial extent (structural height) is reduced. The spring variance is also eliminated, and costs are further reduced owing to the possible omission of further interface components. Since it is no longer necessary for a spring to be supported, for example, on a housing cover that delimits the receiving space, the specification for this is eliminated, such that the cover can also be of simpler form and thus less expensive. A similar situation applies to the design of a housing surface on which the holding ring hitherto had to be supported.

In one refinement, it is proposed that the connecting section is fixed to the inner lateral surface with an interference fit and/or is welded to the inner lateral surface. These are particularly simple and reliable and durable types of connection. If the inner lateral surface is that of a housing cover, the diaphragm cell can be easily pre-installed in the housing cover, whereby a yet further cost saving is possible.

In one refinement, it is proposed that the two diaphragms are welded to one another in the region of a radially outer edge by means of a weld line extending in a circumferential direction, and that the holding device has at least two clamping sections, between which the two diaphragms are clamped in a region radially to the inside of the weld line. In this way, the weld line is relieved of load and thus the durability of the diaphragm cell is improved. The relief of load is based on the fact that the movements of the diaphragms are kept away from the weld line or are at least reduced, such that the bending load on the welded connection is reduced.

In one refinement, it is proposed that at least one of the clamping sections is formed as a single piece with the connecting section. This reduces the number of parts that need to be handled, whereby the assembly process is simplified, and ultimately a yet further cost saving is possible.

In one refinement, it is proposed that the clamping sections are welded to one another. A very enduringly stable unit is created in this way.

In one refinement, it is proposed that the clamping sections are clipped to one another. This can be implemented inexpensively.

In one refinement, it is proposed that the connecting section is formed integrally on the diaphragm cell. A particularly stable and easily installable unit is created in this way.

In one refinement, it is proposed that the two diaphragms are welded to one another in the region of an edge of at least one of the two diaphragms by means of a weld line extending in a circumferential direction, wherein, between the weld line and an interior space formed between the two diaphragms, a region is present in which the two diaphragms lie frictionally against one another at least in certain sections. Here, the weld line is relieved of load with regard to the movements of the diaphragms not by clamping radially to the inside but by frictional engagement between the two diaphragms that is present “radially” to the inside of the weld line. In this way, the relative movements of the two diaphragms during operation are at least substantially kept away from the weld line.

In one refinement, it is proposed that a bend is present between the weld line and the interior space formed between the two diaphragms. Such a “bend” is to be understood as meaning that the two diaphragms are bent, that is to say a type of common collar-like and axially extending section is formed. Here, the bend has an angle of preferably approximately 90° and has a radius, wherein the radius of the inner diaphragm in the region of the bend is smaller than the radius of the outer diaphragm in the region of the bend. Such a bend likewise reduces bending loads that act on the weld line during operation.

In one refinement, it is proposed that, in the region of the bend, a radially inner section of one diaphragm is received with an interference fit in a radially outer section of the other diaphragm. An additional cylindrical interference fit is thus created between the two diaphragms, by means of which intense frictional engagement between the two diaphragms is achieved, which reliably keeps relative movements of the two diaphragms away from the weld line.

Below, an embodiment of the invention will be discussed with reference to the drawing, in which:

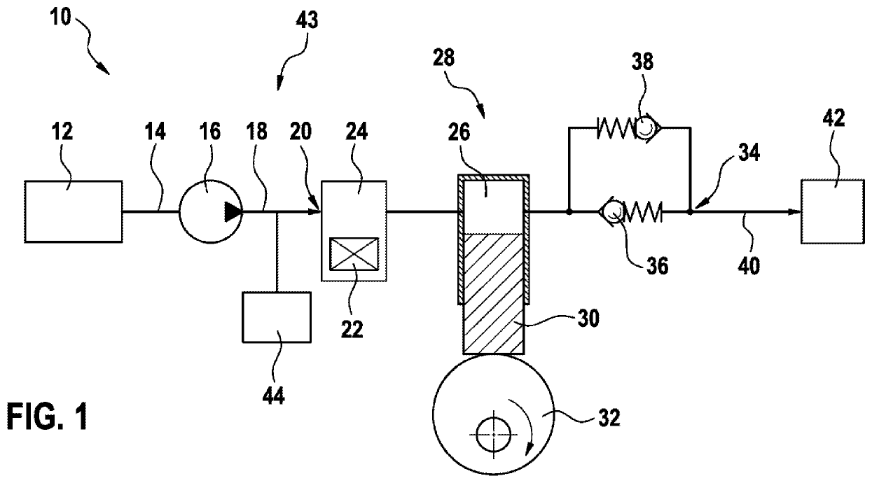

FIG. 1 is a schematic illustration of a fuel system of an internal combustion engine with a high-pressure fuel pump;

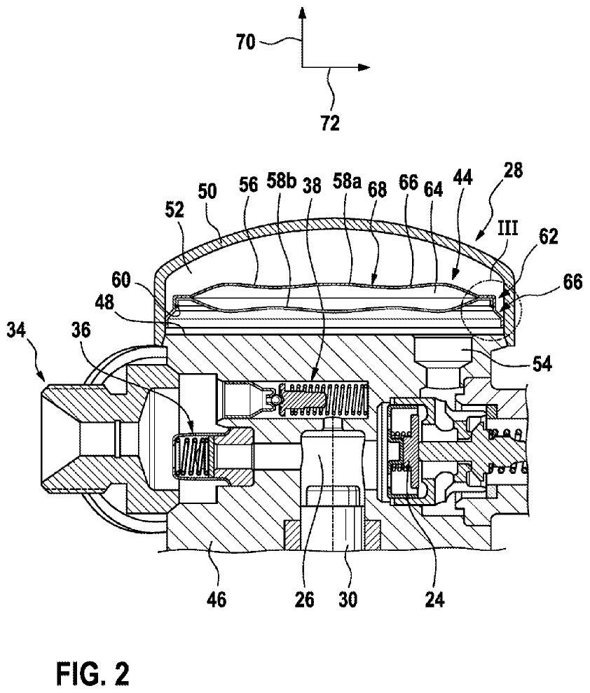

FIG. 2 shows a partial longitudinal section through a region of the high-pressure fuel pump from FIG. 1 in a first embodiment;

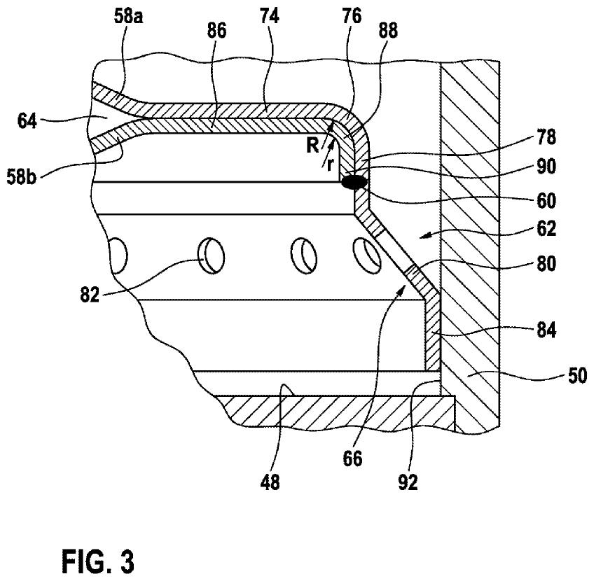

FIG. 3 shows a detail III from FIG. 2;

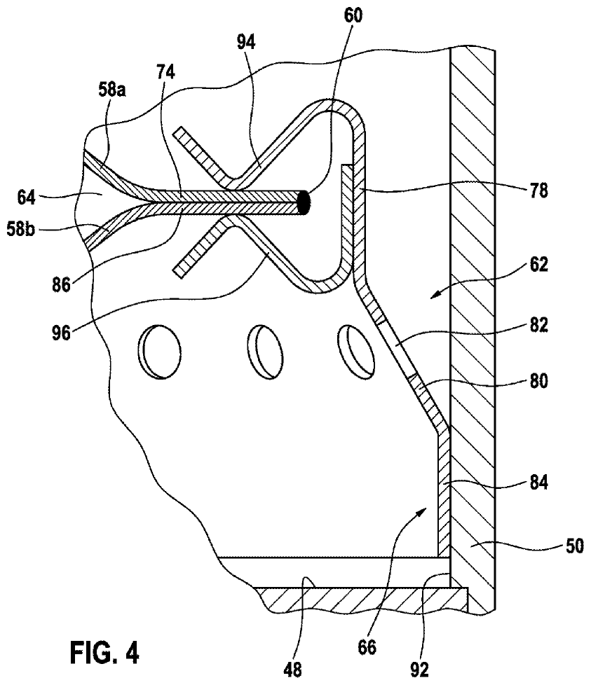

FIG. 4 is an illustration similar to FIG. 3 for a high-pressure fuel pump in a second embodiment;

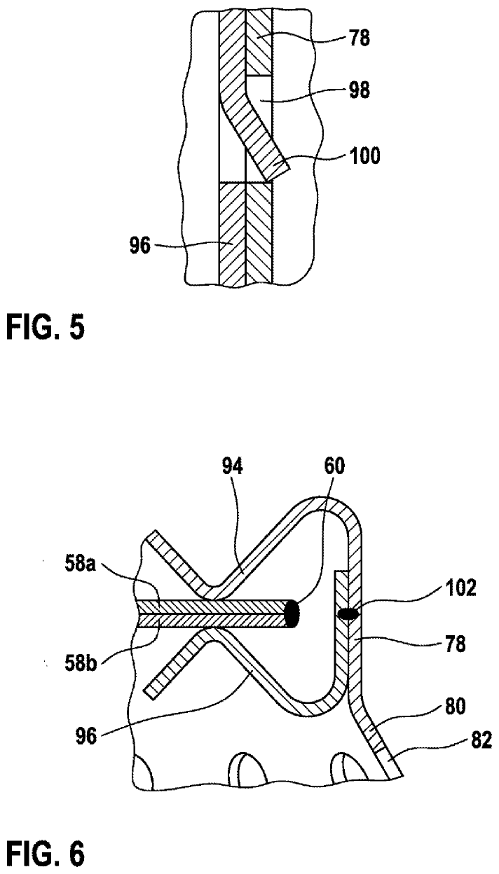

FIG. 5 shows a region of the high-pressure fuel pump from FIG. 4 in a modified embodiment; and

FIG. 6 is an illustration similar to FIG. 5 for a yet further modified embodiment.

Below, functionally equivalent elements and regions are denoted by the same reference designations even in different embodiments.

In FIG. 1, a fuel system is denoted, overall, by the reference designation 10. Said fuel system serves, in a very simplified schematic illustration, for providing fuel for an internal combustion engine (not illustrated in any more detail).

From a fuel tank 12, fuel is fed via a suction line 14, a normally electric predelivery pump 16 and a low-pressure line 18 to an inlet 20 of a flow rate control valve 24, which can be actuated by an electromagnetic actuating device 22, and to a working chamber 26 of a high-pressure fuel pump 28, for example with an admission pressure, provided by the predelivery pump 16, of 4-8 bar, in particular approximately 6 bar. For example, the flow rate control valve 24 may be a positively openable inlet valve of the high-pressure fuel pump 28.

A piston 30 of the high-pressure fuel pump 28 can be moved vertically in the drawing by means of a cam disk 32. Arranged hydraulically between the working chamber 26 and an outlet 34 of the high-pressure fuel pump 28 are an outlet valve 36, shown as a spring-loaded check valve, and a pressure-limiting valve 38, likewise shown as a spring-loaded check valve. The outlet 34 is connected via a high-pressure line 40 to a high-pressure accumulator 42 (“common rail”).

During the operation of the fuel system 10, the predelivery pump 16 delivers fuel from the fuel tank 12 into the low-pressure line 18. The flow rate control valve 24 can be closed and opened in a manner dependent on a respective demand for fuel. The fuel quantity that is delivered to the high-pressure accumulator 42 is influenced in this way. Owing to the discontinuous mode of operation of the high-pressure fuel pump 28, so-called pressure pulsations occur in several sections of the fuel system 10, in particular also upstream of the working chamber 26, that is to say in a low-pressure region 43 of the high-pressure fuel pump 28 or of the fuel system 10. A pressure pulsation damper 44 is arranged there in order to dampen said pressure pulsations.

As can be seen from FIG. 2, the high-pressure fuel pump 28 comprises a pump housing 46, which has a substantially cylindrical or rotationally symmetrical shape. In the upper region of the pump housing 42 in FIG. 2, this has an end side 48, onto which there is placed a hood-like housing cover 50 that is connected in fluid-tight fashion, for example welded, to the pump housing 46. Between the end side 48 and the housing cover 50, there is formed a fluid chamber 52 that is connected via a channel 54 to the low-pressure region 43. The abovementioned pressure pulsation damper 44, which in the present case comprises a diaphragm cell 56, is arranged in the fluid chamber 52. In this respect, the fluid chamber 52 can also be referred to as receiving space.

In the present case, the diaphragm cell 56 in turn comprises two diaphragms 58a and 58b, which in a central region are substantially identical and arranged mirror-symmetrically and which, in plan view, have a substantially circular contour and are of rotationally symmetrical form. As can be seen from FIG. 3, the two diaphragms 58a and 58b are welded to one another in fluid-tight fashion by means of a weld line 60 at their radially outer edge. The diaphragm cell 56 is held in the fluid chamber 52 by means of a holding device 62. The holding device 62 will be discussed in more detail further below. An interior space 64 is formed between the two diaphragms 58a and 58b. Said interior space is thus delimited by the two diaphragms 58a and 58b. This interior space 64 is filled with a gas, for example nitrogen or air, namely at a specific pressure.

The holding device 62 comprises a connecting section 66, which in the present case is formed integrally on the upper diaphragm 58a and thus on the diaphragm cell 56. For this purpose, the upper diaphragm 58a is configured as follows (see also FIG. 3): a working region of the diaphragm 58a is formed by an abovementioned central region 68, in which bead-like formations (without reference designation) are present which run in encircling fashion in a circumferential direction and which allow a movement of the diaphragm 58a in an axial direction 70. Since, as mentioned above, the diaphragms 58a and 58b have a substantially circular contour and are of rotationally symmetrical form, said axial direction 70 can be defined. There is a corresponding radial direction orthogonal with respect to said axial direction. The abovementioned function of the damping of pressure pulsations is achieved by way of the abovementioned movement of the central region 68 of the diaphragm 58a and of the corresponding central region (without reference designation) of the diaphragm 58b.

Radially outside the central region 68, the diaphragm 58a has a radially outwardly extending flat first section 74, which runs in encircling fashion in a circumferential direction. At the radially outer edge thereof, a bend 76 is present by way of which the diaphragm 58a is bent downward through, for example, 90° in the present case. The bend 76 has a radius R. A second section 78 running in encircling fashion in a circumferential direction extends downward in an axial direction, in the form of a cylindrical collar, from the bend 76. Formed integrally on said second section is a third section 80 which runs in encircling fashion in a circumferential direction, specifically obliquely outward at an angle of, for example, approximately 45° in the present case. Distributed uniformly in a circumferential direction in the third section 80 is a multiplicity of openings 82 through which fuel can flow during operation. On the third section 80, in turn, there is integrally formed a fourth section which, in the present case, runs for example in encircling fashion in a circumferential direction and which extends in a straight manner in an axial direction 70, downward in FIG. 3, and which is thus likewise configured in the form of a cylindrical collar.

Radially outside its central region 68, the diaphragm 58b has a likewise radially outwardly extending flat first section 86 running in encircling fashion in a circumferential direction. Present at the radially outer edge thereof is a bend 88 by way of which the diaphragm 58b is bent downward through, for example, 90° in the present case. The bend 88 has a radius r. A second section 90 running in encircling fashion in a circumferential direction extends downward in an axial direction, in the form of a cylindrical collar, from the bend 88. In this way, the second section 90 of the diaphragm 58b forms a radially inner section, and the second section 78 of the diaphragm 58a forms a radially outer section. The second section 90 of the diaphragm 58b however extends less far in the axial direction 70 than the second section 78 of the diaphragm 58a.

At the projecting free edge of the second section 90 of the diaphragm 58b, said diaphragm is welded to the second section 78 of the diaphragm 58a by means of the abovementioned weld line 60. Here, the second and radially inner section 90 of the diaphragm 58b is received with an interference fit in the second and radially outer section 78 of the diaphragm 58a. Furthermore, the bend 76 and the bend 88, and the first section 74 and the first section 86, are joined together so as to lie frictionally against one another. It is achieved in this way that the movement of the central regions 68 of the two diaphragms 58a and 58b are at least substantially kept away from the weld line 60.

The fourth section 84 of the diaphragm 58a is fixed by way of an interference fit to an inner lateral surface 92 of the housing cover 50. In an embodiment that is not shown, said fourth section is additionally or alternatively welded to the inner lateral surface. In this way, the connecting section 66, which in the present case is formed in particular by the bend 76, the second section 78, the third section 80 and the fourth section 84, of the holding device 62 is fixedly connected to the housing cover 50 and thus to the pump housing 46 both in the axial direction 70 and in the radial direction 72. The diaphragm cell 56 is thus held immovably and captively in the housing cover 50.

An alternative embodiment of a holding device 62 will now be discussed with reference to FIG. 4: in this embodiment, the two diaphragms 58a and 58b are of identical design with respect to one another, and the weld line 60 is present at the projecting edge of the first section 74 of the diaphragm 58a and of the second section 86 of the diaphragm 58b. The holding device 62 has two resilient clamping sections 94 and 96 which are preloaded toward one another and between which the first section 74 of the diaphragm 58a and the first section 86 of the diaphragm 58b are clamped. The two diaphragms 58a and 58b are thus clamped in a region radially to the inside of the weld line 60. The upper clamping section 94 in FIG. 4 is formed at the upper edge of the second section 78 of the holding device 62 in FIG. 4, and is thus formed integrally with the connecting section 66, which is formed in the present case predominantly by the second section 78, the third section 80 and the fourth section 84. The lower clamping section 96 in FIG. 4 is fastened to the second connecting section 78 in a manner not illustrated in any more detail in FIG. 4.

The lower clamping section 96 may be fastened to the second section 78 by means of a clip connection with latching action, as can be seen from FIG. 5. For this purpose, in the second section 78, openings 98 are present into which resilient latching lugs 100 of the lower clamping section 96 can latch. Alternatively, the lower clamping section 96 may also simply be welded to the second section 78 (weld line 102), as can be seen from FIG. 6. In both cases, it must be ensured that the two clamping sections 94 and 96 are axially preloaded relative to one another such that a sufficiently strong clamping force is exerted on the first sections 74 and 86 of the diaphragms 58a and 58b.

1. A high-pressure fuel pump comprising:
a pump housing having an inner lateral surface defining a receiving space;
a pressure pulsation damper arranged in the receiving space, the pressure pulsation damper including a diaphragm cell having two diaphragms; and
a holding device configured to hold the diaphragm cell in the receiving space, the holding device comprising a connecting section fixedly connected both in an axial direction and in a radial direction to the pump housing,
wherein the connecting section is fastened both in the axial direction and in the radial direction to the inner lateral surface of the pump housing.

2. The high-pressure fuel pump as claimed in claim 1, wherein the connecting section is fixed to the inner lateral surface with an interference fit and/or is welded to the inner lateral surface.

3. The high-pressure fuel pump as claimed in claim 1, wherein:
the two diaphragms are welded to one another in a region of a radially outer edge by a weld line extending in a circumferential direction, and
the holding device further includes at least two clamping sections, between which the two diaphragms are clamped in a region radially inside of the weld line.

4. The high-pressure fuel pump as claimed in claim 3, wherein at least one clamping section of the at least two clamping sections is formed as a single piece with the connecting section.

5. The high-pressure fuel pump as claimed in claim 3, wherein the at least two clamping sections are welded to one another.

6. The high-pressure fuel pump as claimed in claim 3, wherein the at least two clamping sections are clipped to one another.

7. The high-pressure fuel pump as claimed in claim 1, wherein the connecting section is formed integrally on the diaphragm cell.

8. The high-pressure fuel pump as claimed in claim 1, wherein:
the two diaphragms are welded to one another in a region of an edge of at least one of the two diaphragms by a weld line extending in a circumferential direction, and
between the weld line and an interior space formed between the two diaphragms, a region is present in which the two diaphragms lie frictionally against one another at least in certain sections.

9. The high-pressure fuel pump as claimed in claim 8, wherein a bend is present between the weld line and the interior space formed between the two diaphragms.

10. The high-pressure fuel pump as claimed in claim 9, wherein, in a region of the bend, a radially inner section of one diaphragm of the two diaphragms is received with an interference fit in a radially outer section of the other another diaphragm of the two diaphragms.
